(19) United States
(12) Patent Application Publication
(10) Pub. No.: US 2013/0229679 A1
(43) Pub. Date: Sep. 5, 2013

(54) PRINT SUB-JOB LOGGING

(71) Applicants: Harish B. Kamath, Bengalooru (IN); Karunakaran Sudhakaran, Bangalore (IN); Bhatia Rajesh, Bangalore (IN)

(72) Inventors: Harish B. Kamath, Bengalooru (IN); Karunakaran Sudhakaran, Bangalore (IN); Bhatia Rajesh, Bangalore (IN)

(21) Appl. No.: 13/411,695

(22) Filed: Mar. 5, 2012

(51) Int. Cl. G06F 3/12

(52) U.S. Cl. 358/1.15

(57) ABSTRACT

A print job for a document is communicated to a printer. The print job comprises multiple sub-jobs and each sub-job minimally comprises one extractable object from the document. Sub-job print results associated with the print job are logged.

### BACKGROUND

A print job submitted to a printer is processed and the printer renders it onto paper using the electro-mechanical components. The rendering process causes the printer to move media (e.g. paper) through the printer and apply ink or toner across the width of the paper. Print jobs (e.g. for a document) are commonly recognized by printing sub-systems as successful if all pages of the document are printed by the printer.

### BRIEF DESCRIPTION OF DRAWINGS

The following description includes discussion of figures having illustrations given by way of example of implementations of embodiments of the invention. The drawings should be understood by way of example, not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram illustrating a system according to various embodiments.

FIG. 2 is a block diagram illustrating a system according to various embodiments.

FIG. 3 is a flow diagram of operation in a system according to various embodiments.

FIG. 4 is a flow diagram of operation in a system according to various embodiments.

FIG. 5 is a flow diagram of operation in a system according to various embodiments.

FIG. 6 is a hybrid diagram illustrating an example according to various embodiments.

### DETAILED DESCRIPTION

Described herein are embodiments for logging print sub-jobs. In various printers and print sub-systems, print job results are binary—either the print job is successful or the print job fails. In a failed print job scenario, one or more pages of the print job might print successfully, but because not all pages print successfully the print job is considered to have failed. Furthermore, parts of a page might be printed successfully (e.g. 1^{st} half) while other portions of the page (e.g. 2^{nd} half) are not printed successfully, similarly resulting in a failed print job.

In a pay-for-printing business model where users pay for content that is actually printed as opposed to paying for ink/toner and paper, it is difficult to capture the value of any printed content associated with a failed print job. Embodiments described herein facilitate print tracking and logging at the object level or page level as opposed to the document level. In other words, a print sub-system according to embodiments described herein is capable of dividing a print job into more granular sub-jobs using object extraction in view of sub-job rules defined by a content owner or user.

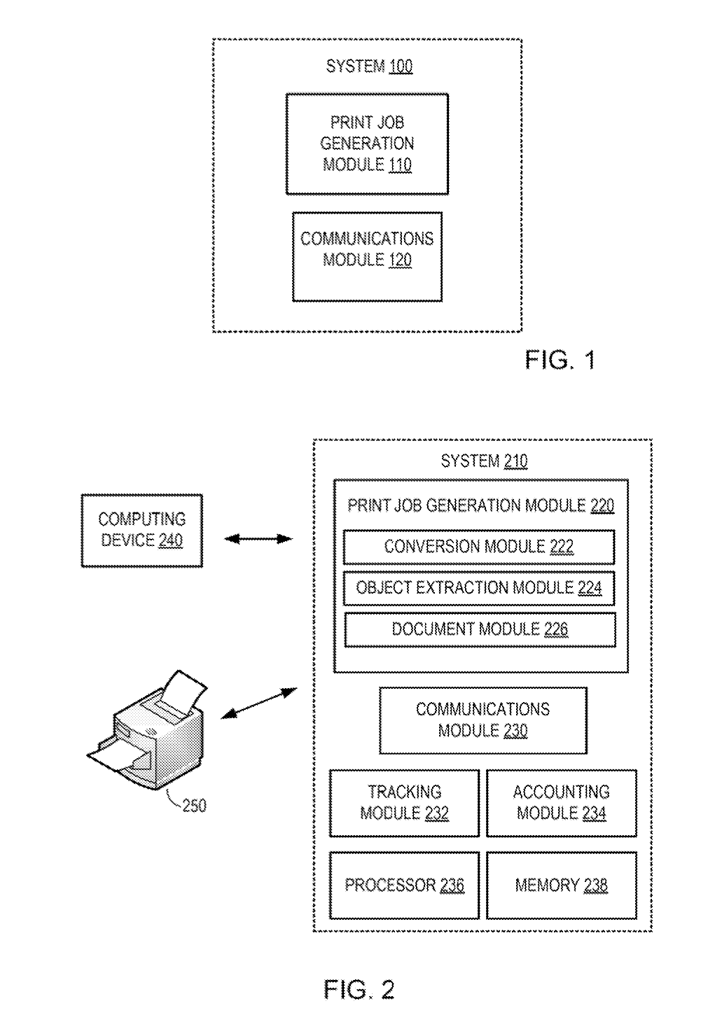

FIG. 1 is a block diagram illustrating a system according to various embodiments. As shown by the dotted line, the modules of system 100 may be incorporated into a single physical device or they may be distributed across multiple physical devices, for example, over a network. Communications module 120 receives print content and content metadata associated with a print job request. For example, the print content could be a document for printing and the content metadata could include selected print options (color vs. black-and-white, portrait vs. landscape, two-sided printing, etc.). In various embodiments, content metadata also includes sub-job definitions and/or rules.

Print job generation module 110 generates a print job from the received print content. In various embodiments, generating the print job includes generating multiple sub-jobs within the print job based at least in part on the content metadata. As used herein, a print sub-job, or simply “sub-job,” refers to a defined portion (i.e. something less than the whole) of the print content associated with a print job request. As used herein, a sub-job minimally comprises one extractable object (e.g., an image, text segment, etc.) from the printed content. In other words, a sub-job may be as granular as a single object, though a sub-job could be composed of multiple objects on a single page or over multiple pages of a document so long as the sub-job does not include the whole of the print content for the document.

Communications module 120 communicates sub-jobs to a printer in an ordered sequence where a next sub-job is provided to the printer in response to receiving an indication that a pending sub-job has been completed. In other words, the sequence of sub-jobs is communicated one at a time to the printer where completion of one sub-job is the trigger for sending the next sub-job. Once all sub-jobs have been completed, communications module 120 receives an indication from the printer that the print job has completed.

FIG. 2 is a block diagram illustrating a system according to various embodiments. FIG. 2 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these. Various modules and/or components illustrated in FIG. 2 may be implemented as a non-transitory computer-readable storage medium containing instructions executed by a processor (e.g., processor 236) and stored in a memory (e.g., memory 238) for performing the operations and functions discussed herein.

In the example system illustrated in FIG. 2, the modules and components of system 210 may be integrated into a single physical computing device or they may be physically distributed among multiple computing devices connected, for example, over a network.

Communications module 230 receives print content and content metadata associated with a print job request from computing device 240 over a network (e.g. the Internet). For example, the print content could be a document for printing and the content metadata could include selected print options (color vs. black-and-white, portrait vs. landscape, two-sided printing, etc.). In various embodiments, content metadata also includes sub-job definitions and/or rules.

Print job generation module 220 generates a print job from the received print content. In particular, conversion module 222 may convert the print content into an intermediate format. For example, the print content may reside on computing device 240 as a word processing document, a spreadsheet, a web page document, or other format. In various embodiments, conversion module 222 converts the print content into PDF (Portable Document Format, an open standard for document exchange, made available by Adobe Systems, Inc. of Mountain View, Calif.). The conversion could be a conversion into other suitable intermediate formats such as XPS (XML Paper Specification) in other embodiments. Print content may be received in a suitable intermediate format and therefore not need to be converted. In other words, conversion to an intermediate format (e.g. PDF, XPS, etc.) is optional depending on the format in which a document is received. PDF and other suitably formatted documents are structured in a tree hierarchy (e.g. with the document level being at the top of the hierarchy, followed by page level, and then object level, etc.). Given this structure, PDF documents may be parsed into extractable objects (e.g. images, graphic elements, text segments, etc.).

Once in PDF format (or other suitable format for object extraction), object extraction module 224 determines object locations and/or sizes (e.g. defined by coordinates) within the document. Images and other objects, also known as raster images or “Image XObjects” in PDF parlance, are represented by dictionaries containing page descriptions with an associated stream. In simpler terms, a PDF is like an envelope that contains various objects (images, text segments, etc.) along with associated object metadata. Object extraction module 224 extracts objects from the document based at least in part on sub-job boundary metadata from the document. Sub-job boundaries may be defined by a publisher, content owner, service provider, or user in different embodiments.

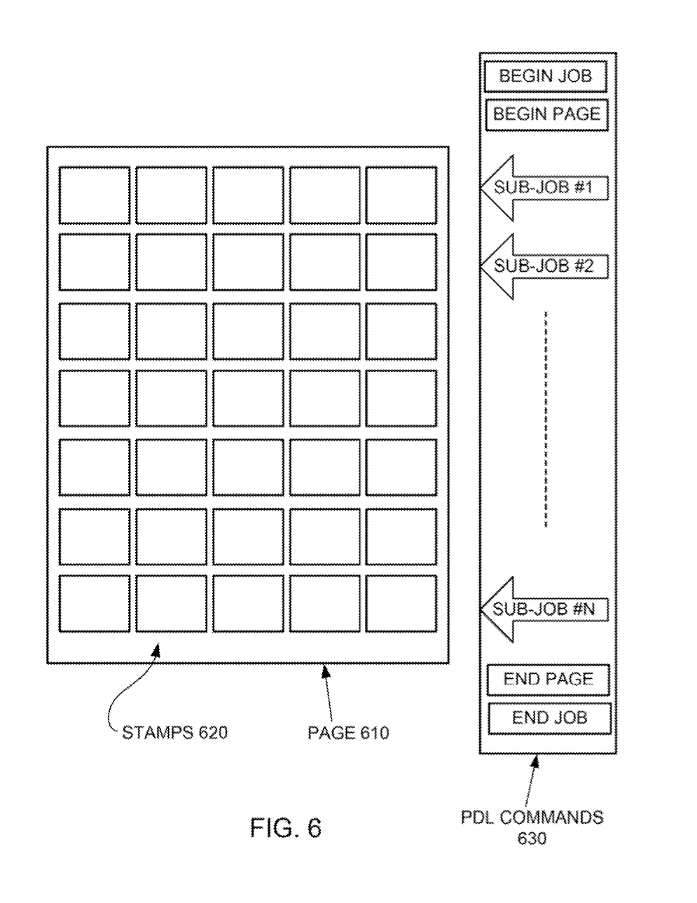

In an example, consider printing a page full of postage stamps where each stamp has an associated cost. Images of postage stamps are placed next to each other and may be visualized as rows of information to print. FIG. 6 depicts stamps on a page. Given that each object (i.e. stamp) in this example is the same size, the sub-job boundary may be based simply on the height of a single object. Based on the boundary, object extraction module 224 extracts objects that fit within the boundary (e.g., first row of stamps, second row of stamps, etc.) and document module 226 creates a separate sub-job job document for each set of objects that satisfies the boundary requirement. Depending on the boundary requirements, multiple sub-job documents (e.g. PDF documents) may be created from a single page of content. This is illustrated by the PDL (page description language) pseudo-commands 630 in FIG. 6.

In pseudo-command parlance, the contents of a print job are wrapped between a “begin job” descriptor and an “end job” descriptor. Pages within the print job are bound by “begin page” and “end page” descriptors. Accordingly, print job generation module 220 inserts sub-job documents created by document module 226 within page boundaries of the print job document. In addition to inserting multiple sub-job documents into a page wrapper, multiple print job documents could be inserted into a single print job wrapper.

Conversion module 222 converts the print job document and any sub-job documents contained in the print job into a print ready format. For example, conversion module 222 may perform rasterization on the print job document and any sub-job documents using a page description language such as PostScript (available from Adobe Systems, Inc.) or PCL (Printer Control Language, available from Hewlett-Packard Company of Palo Alto, Calif.). In various embodiments, multiple sub-jobs may be processed (e.g. created and/or converted to print-ready format) in parallel.

In connection with converting the print job document and any sub-job documents to a print-ready format, communications module 230 sends the print job document in print-ready format to a printer. In particular, sub-jobs are sent to the printer in an ordered sequence. Communications module 230 receives an indication from the printer when a sub-job has completed (e.g. successfully). This indication triggers the next sub-job in the queue to be sent to the printer. In other words, the next sub-job at the top of the queue is held in the queue until the pending sub-job (i.e. the most recent sub-job sent to the printer) is completed.

Tracking module 232 tracks successful completion of sub-jobs by the printer. Tracking module 232 may also track failed sub-jobs for auditing purposes and/or print job restarts. As discussed above, an indication of completion of a sub-job triggers a next sub-job to be sent to the printer. This indication is stored and/or tracked by tracking module 232. In view of the sub-job details (e.g. size, type of content—image vs. text, quality parameters, etc.), accounting module 234 generates a user charge for each completed sub-job. For example, larger sub-jobs and/or color sub-jobs may incur a higher charge than smaller black-and-white sub-jobs. In addition, the nature of the content itself may incur certain charges. For example, printing stamps might incur a surcharge for the cost of the stamp. Certain types of copyrighted content may also incur pre-defined charges.

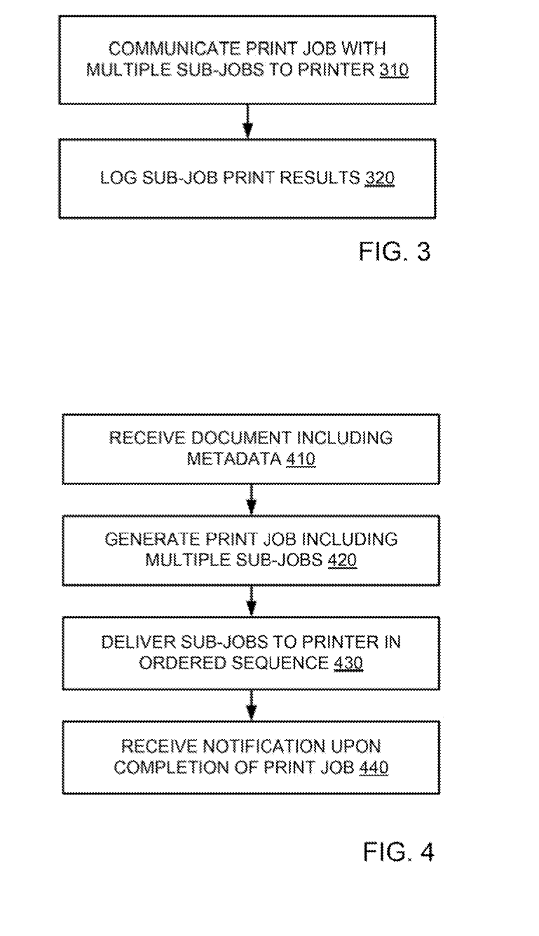

FIG. 3 is a flow diagram of operation in a system according to various embodiments. FIG. 3 includes particular operations and execution order according to certain embodiments. However, in different embodiments, other operations, omitting one or more of the depicted operations, and/or proceeding in other orders of execution may also be used according to teachings described herein.

A system communicates 310 a print job for a document to a printer. In various embodiments, the printer is a network-connected printer registered or connected with the system. The print job communicated to the printer comprises multiple sub-jobs generated via object extraction in view of at least one sub-job rule. As discussed above, a sub-job refers to a defined portion (i.e. something less than the whole) of the print content associated with a print job request. A sub-job minimally comprises one extractable object (e.g., an image, text segment, etc.) from the printed content. In other words, a sub-job may be as granular as a single extractable object, though a sub-job could be composed of multiple objects over multiple pages of a document so long as the sub-job does not include the whole of the print content for the document.

The system logs 320 sub-job print results associated with the print job. For example, rather than sending a print job and receiving a single indication that the print job has completed (e.g. successful or failed), sub-job print results are separately communicated back to the system and those results are logged.

FIG. 4 is a flow diagram of operation in a system according to various embodiments. FIG. 4 includes particular operations and execution order according to certain embodiments. However, in different embodiments, other operations, omitting one or more of the depicted operations, and/or proceeding in other orders of execution may also be used according to teachings described herein.

A system receives 410 a document including document metadata from a user. For example, a user may send a document for printing over a network (e.g. Internet) from his/her mobile device or other computing device. Based on the document metadata, the system generates 420 a print job for the document which includes generating multiple sub-jobs within the print job. The document metadata may include printing properties, finishing properties, etc. In addition, the document metadata may include one or more sub-job rules. Sub-job rules may define a size and/or location boundary for objects to be included in a particular sub-job or a set of sub-jobs. In other words, the sub-job rule(s) defines how to parse a print job into sub-jobs.

In the example illustrated in FIG. 6, the stamps are of equal size and may be treated as vector rows of data. The sub-job rule to handle these types of objects in this type of layout may be fixed and relatively straightforward. However, sub-job rules may be extended to other detectable PDF objects, including, but not limited to, forms. If a sub-job is defined by a row of objects, each object should be fully contained within the row boundary. Accordingly, if a row includes objects of different sizes (heights in particular), the system (e.g. via an objection extraction module) may employ a variable row boundary based on detection of object locations and sizes. For example, the system might find a first object and create a test boundary based on the size of the first object. If no objects in the test row cross over the boundary, then the test boundary might be selected as the boundary for that row. If there is boundary overlap by one or more objects, the system can test a new boundary line based on the size (e.g. height) of an object that crossed over the previous test boundary line. This process may be iterated until an acceptable boundary line is determined.

Generation of sub-jobs may include generating a separate document (e.g. PDF document) for each sub-job. Multiple sub-jobs may be wrapped into a single page descriptor boundary within a print job document. Each sub-job document is separately converted to print-ready format (e.g. PCL, PostScript, etc.) prior to being sent to the printer. Processing of sub-jobs may be done in parallel. The system delivers 430 sub-jobs to the printer in an ordered sequence. In other words, a second sub-job is not delivered to the printer until a notification has been received that the first sub-job has successfully printed. In addition to receiving notifications for completed sub-jobs, the system receives 440 a notification upon completion of the entire print job.

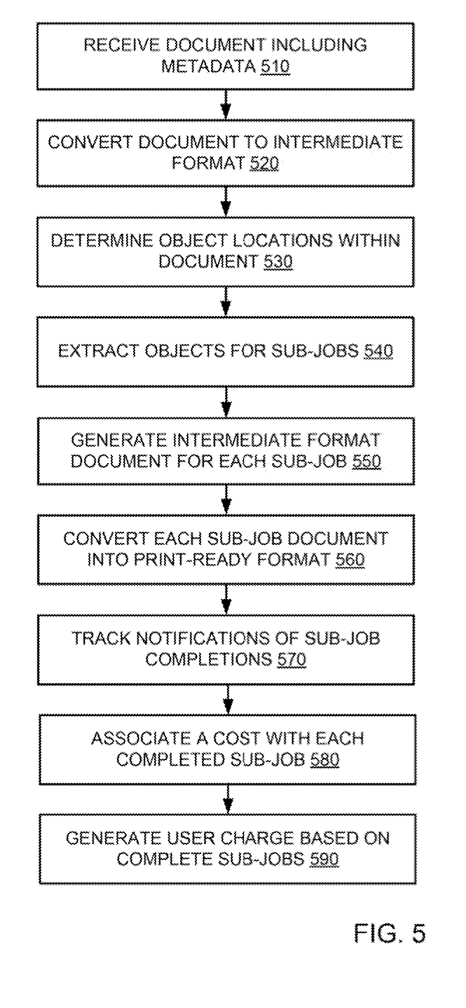

FIG. 5 is a flow diagram of operation in a system according to various embodiments. FIG. 5 includes particular operations and execution order according to certain embodiments. However, in different embodiments, other operations, omitting one or more of the depicted operations, and/or proceeding in other orders of execution may also be used according to teachings described herein.

A system receives 510 a document including document metadata. The document may be received in PDF format or other suitable format for object extraction, in which case document conversion is not necessary. However, if the received document is not in PDF or other suitable format, the system converts 520 the document into a suitable intermediate format (e.g. PDF). With the document in the appropriate intermediate format, the system determines 530 object locations and/or sizes within the document. Objects may be images, text segments, forms, etc. Based on the object locations and/or sizes and in view of the document metadata (e.g. sub-job rule or boundary information), the system extracts 540 objects for creating sub-jobs. In various embodiments, a separate intermediate format document (e.g. PDF) is generated 550 for each sub-job.

The system converts 560 each sub-job document into print-ready format (e.g. PCL, PostScript, etc.) prior to sending sub-jobs to a printer as part of a print job. This processing may be done in parallel for some or all of the sub-jobs. The system receives and tracks 570 notifications from the printer of completed sub-jobs. A cost is associated 580 with each completed sub-job. For example, the cost might be a generic cost based on the size of the sub-job or print qualities (e.g. color vs. black-and-white, etc.). The cost could be a specific cost for the sub-job based on the nature of the content included in the sub-job. For example, in printing stamps, each stamp has a specified cost/value associated with it. Certain copyrighted material and other content could also have a specific cost associated with it. Any or all of these costs could be factored into the cost of a sub-job. Based on the aggregated cost of all the completed sub-jobs, the system generates 590 a user charge for the whole print job. The total charge could simply be the aggregated cost of the completed sub-jobs or additional charges or discounts could be applied in view of other factors (e.g. volume, loyalty, membership benefits, etc.).

Various modifications may be made to the disclosed embodiments and implementations of the invention without departing from their scope. Therefore, the illustrations and examples herein should be construed in an illustrative, and not a restrictive sense.

What is claimed is:

1. A non-transitory computer-readable storage medium containing instructions, that when executed, cause a computer to:
communicate a print job for a document to a printer where the print job comprises multiple sub-jobs generated via object extraction in view of at least one sub-job rule; and
log sub-job print results associated with the print job.

2. The non-transitory computer-readable storage medium of claim 1, comprising further instructions that cause the computer to:
parse the document into sub-jobs based at least in part on a sub-job rule associated with the document upon receiving the document as a print job request.

3. The non-transitory computer-readable storage medium of claim 1, comprising further instructions that cause the computer to:
wrap multiple sub-jobs within a single page descriptor boundary.

4. The non-transitory computer-readable storage medium of claim 1, comprising further instructions that cause the computer to:
generate a user charge based at least in part on successfully printed sub-jobs.

5. The non-transitory computer-readable storage medium of claim 1, comprising further instructions that cause the computer to:
process multiple sub-jobs in parallel; and
serially dispatch sub-jobs to a printer where a next sub-job is dispatched in response to an indication that a pending sub-job has been printed successfully.

6. A method, comprising:
receiving a document including document metadata from a user;
generating a print job for the document including generating multiple sub-jobs within the print job based at least in part on the document metadata;
delivering sub-jobs to a printer in an ordered sequence where a next sub-job is delivered to the printer after receiving a notification that a pending sub-job has been completed; and
receiving a notification from the printer upon completion of the print job.

7. The method of claim 6, wherein generating multiple sub-jobs for the print job comprises wrapping multiple sub-jobs within a single page descriptor boundary.

8. The method of claim 6, wherein a sub-job is minimally comprised of a row vector of object information for the document.

9. The method of claim 6, wherein generating multiple sub-jobs comprises:
converting the document into an intermediate format having extractable objects if the received document is in a format lacking extractable objects;
determining object coordinates within the document;
extracting objects for respective sub-jobs based at least in part on sub-job boundary metadata from the document;
generating a sub-job document for each sub-job; and
converting each sub-job document into a print-ready format.

10. The method of claim 6, wherein generating multiple sub-jobs comprises generating multiple sub-jobs in parallel.

11. The method of claim 6, further comprising:
tracking notifications of sub-jobs completed by the printer;
associating a cost with each completed sub-job;
generating a user charge for the print job based at least in part on completed sub-jobs.

12. A system, comprising:
a communications module to receive over a network from a user print content and content metadata associated with a print job request;
a print job generation module to generate a print job from the print content including generating multiple sub-jobs for the print job based at least in part on the content metadata;
the communications module to provide sub-jobs over a network to a network-connected printer in an ordered sequence where a next sub-job is provided to the printer in response to receiving an indication that a pending sub-job has been completed; and
the communications module to receive an indication from the network-connected printer upon completion of the print job.

13. The system of claim 12, the print job generation module further to wrap multiple sub-jobs into a single page descriptor boundary.

14. The system of claim 12, wherein a sub-job is minimally comprised of a row vector of object information for print content.

15. The system of claim 12, the print job generation module further comprising:
an object extraction module to determine object locations within the document and extract objects for respective sub-jobs based at least in part on sub-job boundary metadata from the document;
a document module to create a sub-job document for each object associated with each sub-job; and
a conversion module to convert each sub-job document into a print-ready format.

16. The system of claim 15, further comprising:
a conversion module to convert the print content into an intermediate format having extractable objects before passing the document to the object extraction module.

17. The system of claim 12, wherein generating multiple sub-jobs comprises processing multiple sub-jobs in parallel.

18. The system of claim 12, further comprising:
A tracking module to track successful completion of sub-jobs by the network-connected printer;
an accounting module to associate a cost with each sub-job;
the accounting module to generate a user charge for the print job based at least in part on completed sub-jobs.
